(19) United States
(12) Patent Application Publication
(10) Pub. No.: US 2023/0237089 A1
(43) Pub. Date: Jul. 27, 2023

(54) METHOD OF PROCESSING MULTIMODAL RETRIEVAL TASKS, AND AN APPARATUS FOR THE SAME

(71) Applicant: SAMSUNG ELECTRONICS CO., LTD., Suwon-si (KR)

(72) Inventors: Zhiming HU, Vaughan (CA); Lan Xiao, Maple (CA); Mele Kemertas, Toronto (CA); Caleb Ryan Phillips, Bobcaygeon (CA); Igbal Ismail Mohomed, Markham (CA); Afsaneh Fazly, Auarora (CA)

(73) Assignee: SAMSUNG ELECTRONICS CO., LTD., Suwong-si (KR)

(21) Appl. No.: 18/099,711

(22) Filed: Jan. 20, 2023

Related U.S. Application Data
(60) Provisional application No. 63/301,879, filed on Jan. 21, 2022.

(51) Int. Cl. G06F 16/538; G06F 16/2455

(52) U.S. Cl. CPC G06F 16/538; G06F 16/2455

(57) ABSTRACT

A method for multimodal content retrieval, may include: receiving a search query corresponding to a request for content; aggregating word features extracted from the search query based on a first set of learned weights; aggregating region features extracted from each of a plurality of images, based on a second set of learned weights, independently of the word features; computing a similarity score between the aggregated words features and the aggregated region features for each of the plurality of images; selecting candidate images from the plurality of images based on the similarity scores between each of the plurality of images and the search query; and selecting at least one final image from the candidate images as a response to the search query, based on attended similarity scores of the candidate images with respect to the search query.

### CROSS-REFERENCE TO RELATED APPLICATION(S)

This application is based on and claims priority under 35 U.S.C. § 119 to U.S. Provisional Patent Application No. 63/301,879, filed on Jan. 21, 2022, in the U.S. Patent & Trademark Office, the disclosure of which is incorporated by reference herein in its entirety.

### BACKGROUND

### 1. Field

The disclosure relates to a method of processing multimodal tasks, and an apparatus for the same, and more particularly to a method of using a combination of a coarse search model and a fine search model to process multimodal retrieval tasks, and an apparatus for the same.

### 2. Description of Related Art

Advances in deep learning have enabled accurate language-based search and retrieval over user photos in the cloud. Many users prefer to store their photos in the home due to privacy concerns. As such, a need arises for models that can perform cross-modal search on resource-limited devices. State-of-the-art cross-modal retrieval models achieve high accuracy through learning entangled representations that enable fine-grained similarity calculation between a language query and an image, but at the expense of having a prohibitively high retrieval latency. Alternatively, there is a new class of methods that exhibits good performance with low latency, but requires a lot more computational resources, and an order of magnitude more training data (i.e. large web-scraped data sets consisting of millions of image-caption pairs) making them infeasible to use in a commercial context. None of the existing methods are suitable for developing commercial applications for low-latency cross-modal retrieval on low-resource devices.

Therefore, there has been a demand for a multimodal content retrieval system that reduces the retrieval latency with minimal loss in ranking accuracy for on-device language-based image retrieval.

### SUMMARY

Example embodiments address at least the above problems and/or disadvantages and other disadvantages not described above. Also, the example embodiments are not required to overcome the disadvantages described above, and may not overcome any of the problems described above.

According to an aspect of the present disclosure, a method for multimodal content retrieval, may include: receiving a search query corresponding to a request for content; aggregating word features extracted from the search query based on a first set of learned weights; aggregating region features extracted from each of a plurality of images, based on a second set of learned weights, independently of the word features; computing a similarity score between the aggregated words features and the aggregated region features for each of the plurality of images; selecting candidate images from the plurality of images based on the similarity score for each of the plurality of images; and selecting at least one final image from the candidate images as a response to the search query, based on attended similarity scores of the candidate images with respect to the search query.

The similarity score is calculated based on performing a negative Euclidean distance operation or a cosine similarity operation on the aggregated word features and the aggregated region features.

The aggregating of the word features may include: obtaining the first set of learned weights to be assigned to the word features based on content values of the word features independently of the region features, and wherein the aggregating the region features may include: obtaining the second set of learned weights to be assigned to the region features based on content values of the region features independently of the word features.

The content values of the word features may be vector values corresponding to contextual representation of words in the search query.

The content values of the region features may be calculated by: detecting salient regions or grid cells in each of the plurality of images; mapping the detected salient regions or grid cells to a set of vectors; and averaging the set of vectors.

The aggregating of the word features may include: transforming the word features by projecting the word features into a feature subspace, and aggregating the transformed word features based on the first set of learned weights.

The aggregating of the region features may include: transforming the region features by projecting the region features into a feature subspace, and aggregating the transformed region features based on the second set of learned weights.

The word features may be aggregated via a first multilayer perceptron (MLP) network, and the region features may be aggregated via a second MLP network.

The selecting of the candidate images may include: comparing the similarity scores between each of the plurality of images and the search query with a preset threshold, and selecting the candidate images each of which has the similarity score that is greater than the preset threshold.

According to another aspect of the present disclosure, an electronic device for multimodal content retrieval, may include: at least one memory storing instructions; and at least one processor configured to execute the instructions to: receive a search query corresponding to a request for content; aggregate word features extracted from the search query based on a first set of learned weights; aggregate region features extracted from each of a plurality of images, based on a second set of learned weights, independently of the word features; compute a similarity score between the aggregated words features and the aggregated region features for each of the plurality of images; select candidate images from the plurality of images based on the similarity scores between each of the plurality of images and the search query; and select at least one final image from the candidate images as a response to the search query, based on attended similarity scores of the candidate images with respect to the search query.

The at least one processor may be further configured to execute the instructions to: calculate the similarity score based on performing a negative Euclidean distance operation or a cosine similarity operation on the aggregated word features and the aggregated region features.

The at least one processor may be further configured to execute the instructions to: obtain the first set of learned weights to be assigned to the word features based on content values of the word features independently of the region features, and obtain the second set of learned weights to be assigned to the region features based on content values of the region features independently of the word features.

The content values of the word features may be vector values corresponding to contextual representation of words in the search query.

The at least one processor may be further configured to execute the instructions to: calculate the content values of the region features by: detecting salient regions or grid cells in each of the plurality of images; mapping the detected salient regions or grid cells to a set of vectors; and averaging the set of vectors.

The at least one processor may be further configured to execute the instructions to: transform the word features by projecting the word features into a feature subspace, and aggregate the transformed word features based on the first set of learned weights.

The at least one processor may be further configured to execute the instructions to: transform the region features by projecting the region features into a feature subspace, and aggregate the transformed region features based on the second set of learned weights.

The at least one processor may be further configured to execute the instructions to: aggregate the word features via a first multilayer perceptron (MLP) network, and aggregate the region features via a second MLP network.

The at least one processor may be further configured to execute the instructions to: compare the similarity scores between each of the plurality of images and the search query with a preset threshold, and select the candidate images each of which has the similarity score that is greater than the preset threshold.

Additional aspects will be set forth in part in the description that follows and, in part, will be apparent from the description, or may be learned by practice of the presented embodiments of the disclosure.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 and FIG. 2 are diagrams showing a computer system for multimodal image retrieval according to embodiments of the present disclosure;

FIG. 3 is a flowchart illustrating a method of performing multimodal image retrieval according to embodiments of the present disclosure;

FIG. 4 is a flowchart illustrating a method of selecting candidate images via a coarse search model according to embodiments of the present disclosure;

FIG. 5 is a flowchart illustrating a method of selecting final images from the candidate images via a fine search model according to embodiments of the present disclosure;

FIG. 6 is a diagram of electronic devices for performing a multimodal retrieval task according to embodiments of the present disclosure;

FIG. 7 is a diagram of components of one or more electronic devices of FIG. 6 according to embodiments of the present disclosure; and

FIG. 8 is a diagram of a mobile device according to embodiments of the disclosure.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

The term “module” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

One or more example embodiments provide a multimodal content retrieval system that combines a light-weight and runtime-efficient coarse model with a fine re-ranking model to reduce the retrieval latency with minimal loss in ranking accuracy for on-device language-based image retrieval. The multimodal content retrieval system may have a cascade structure, including a coarse search model followed by a fine search model.

Given a language query and a large search space (e.g., a smartphone gallery with thousands of images), the coarse search model may perform a fast approximate search (i.e., a coarse search) to filter out a large fraction of candidate images (e.g., irrelevant image candidates). After this filtering, only a handful of strong candidates may be selected and sent to a fine model for re-ranking. Specifically, the multimodal content retrieval system may apply the fine search model (e.g., a cross-attention based search model) to the resulting candidate images to arrive at a final retrieval decision.

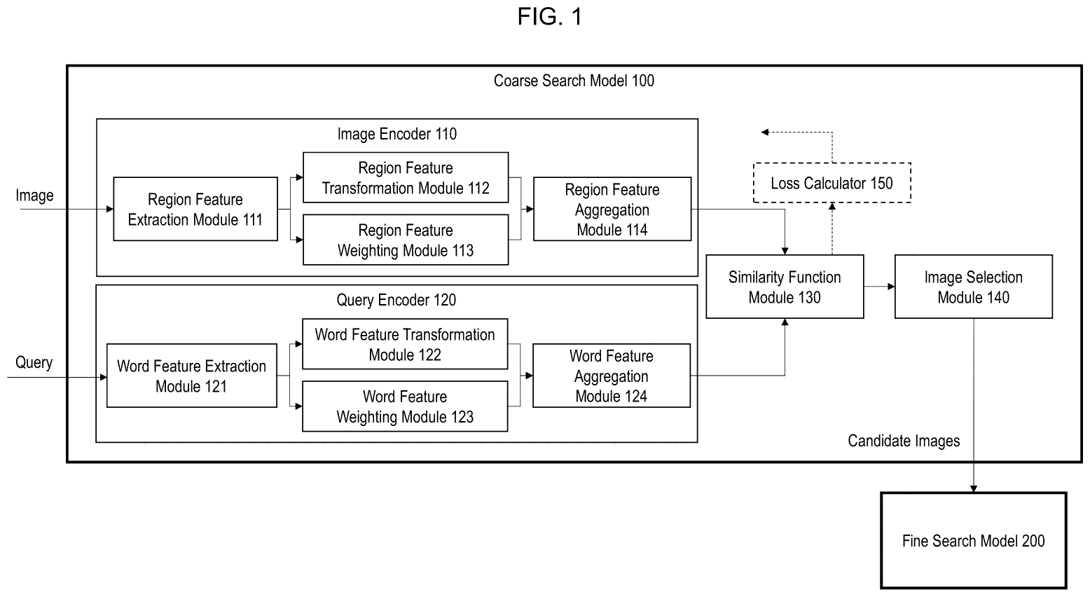

FIG. 1 is a diagram showing a computer system for retrieving images in response to a query according to embodiments of the present disclosure. The computer system may include one or more neural networks to use artificial intelligence (AI) technologies.

As shown in FIG. 1, the computer system may include a coarse search model 100 and a fine search model 200 that are connected in a cascade manner. The coarse search model 100 may receive a query from a user input, and may receive a plurality of images one-by-one in sequence. The images may be retrieved from a data storage, and for example, may be all the images in a photo gallery of a mobile device. The coarse search model 100 may select candidate images corresponding to the query, from the plurality of images, without using a cross-attention algorithm, but instead using an approximated cross-attention algorithm. The candidate images that are selected by the coarse search model 100 may be provided to the fine search model 200 so that the fine search model 200 selects at least one final image to be presented to a user in response to the query. The fine search model 200 may apply a cross-attention based approach that uses word-region similarities as weights in aggregating the region features, but the fine search model 200 may not be limited thereto and may use a different algorithm.

Specifically, the coarse search model 100 may include an image encoder 110, a query encoder 120, a similarity function module 130, and an image selection module 140. Additionally, the coarse search model 100 may include a loss calculator 150 when an electronic device including the coarse search model 100 updates the coarse search model 100 based on on-device learning. The loss calculator 150 may be omitted if the electronic device uses the coarse search model 100 as a pre-trained fixed model.

The image encoder 110 may include a region feature extraction module 111, a region feature transformation module 112, a region feature weighting module 113, and a region feature aggregation module 114. Each of the region feature transformation module 112 and the region feature weighting module 113 may include a multi-layer multilayer perceptron (MLP) network (e.g., a two-layer MLP network).

The region feature extraction module 111 may extract region features from an image, which capture spatial information (e.g., the appearance of objects and/or scenes) in the image. Content values of the region features may be calculated by detecting salient regions or grid cells in the image, mapping the detected salient regions or grid cells to a set of vectors, and averaging the set of vectors.

The spatial information may enable the image encoder 110 to remove regions of the image including uninformative scenes or objects. The region feature extraction module 111 may be embodied as a two-dimensional (2D) convolutional neural network (CNN), a R-CNN, a fast R-CNN, or a faster R-CNN. For example, when an image capturing a dog playing with a toy is provided to the region feature extraction module 111, the region feature extraction module 111 may identify a first region of the dog and a second region of the toy from the image, and may extract a region feature from each of the first region and the second region (e.g., a first vector representing the first region and a second vector representing the second region of the image). The extracted region features are fed into the region feature transformation module 112 and the region feature weighting module 113, respectively.

The region feature transformation module 112 may include a linear projection layer to project the region features to a feature subspace (also referred to as “joint embedding space”) where semantically similar feature points in different modalities (i.e., image and text) are placed closer to each other in distance. The projection layer may apply a region feature transform function ƒₜ^{r} (r_{k,j})∈ [symbol] ^{d} which transforms region features rₖ of m regions of an image iₖ to a joint embedding space [symbol] having a constant dimension d, wherein rₖ={r_{k,j}∈ [symbol] ^{d}|j∈1, . . . m}.

The region feature weighting module 113 may provide a learnable weight function ƒ_{w}^{r}(r_{k,j})∈ [symbol] , which is optimized to assign higher weights w to important regions among the m regions of the image iₖ. The region feature weighting module 113 may load a set of weights which are pre-stored in a memory, and may update the weights using the learnable weight function for the region features according to a loss calculated by the loss calculator 150 (and/or a loss calculated by the loss calculator 250 included in the fine search model 200).

The region feature aggregation module 114 may apply the weights w to the transformed region features and the aggregated the weighted region features, for example, via mean pooling. For example, region feature aggregation module 114 may compute the aggregated region features \hat{r}ₖ independent of the query as follows:

\hat{r}ₖ=Σⱼ₌₁^{m}(ƒ_{w}^{r}(r_{k,j})·ƒₜ^{r}(r_{k,j})) Equation (1)

The query encoder 120 may include a word feature extraction module 121, a word feature transformation module 122, a word feature weighting module 123, and a word feature aggregation module 124. Each of the word feature extraction module 121 and the word feature weighting module 123 may include a multi-layer multilayer perceptron (MLP) network (e.g., a two-layer MLP network).

The query encoder 120 may receive a query via a touch screen, a keyboard, a microphone, and/or a communication interface. When the query is received through a voice signal, speech-to-text conversion may be performed on the voice signal to obtain text information corresponding to speech in the voice signal.

The word feature extraction module 121 may extract word features from one or more words included in the query (e.g., a vector representing each of the words). For example, when a query stating “a woman is throwing a Frisbee in the park” is provided to the word feature extraction module 121, the word feature extraction module 121 may identify four words, “woman,” “throwing,” “Frisbee” and “park” in the query, and may extract a word feature from each of the words. The extracted word features are fed into the word feature extraction module 122 and the word feature weighting module 123, respectively. The word features have content values that are vector values corresponding to contextual representation of words in the query.

The word feature transformation module 122 may include a linear projection layer to project the word features to the joint embedding space to which both the region features and the word features are projected. The projection layer may apply a word feature transform function ƒₜ^{q}(q⁽ⁱ⁾)∈ [symbol] ^{d} which transforms word features q⁽ⁱ⁾ of n words included in the query to the joint embedding space [symbol] having the constant dimension d, wherein q⁽ⁱ⁾∈ [symbol] ^{d}, wherein i∈1, . . . n.

The word feature weighting module 123 may provide a learnable weight function ƒ_{w}^{q}(q⁽ⁱ⁾)∈ [symbol] , which is optimized to assign higher weights w to relatively more important words among the n words included in the query. The region feature weighting module 113 may load a set of weights which are pre-stored in a memory, and may update the weights using the learnable weight function for the word features according to a loss calculated by the loss calculator 150 (and/or a loss calculated by the loss calculator 250 included in the fine search model 200).

The word feature aggregation module 124 may apply the weights w to the transformed word features and the aggregated the weighted word features, for example, via mean pooling. For example, the word feature aggregation module 124 may compute the aggregated word features q⁽ⁱ⁾, independent of the region regions as follows:

\tilde{s}ₖ=h(\hat{r}ₖ, Σᵢ₌₁ⁿ(ƒ_{w}^{q}(q⁽ⁱ⁾)·ƒₜ^{q}(q⁽ⁱ⁾))) Equation (2)

During a training process, the similarity function module 130 may compute a similarity score of a matching query-image pair \tilde{s}(q, i) and similarity scores of non-matching query-image pairs \tilde{s}(q, i′) and \tilde{s}(q′, i). For example, a cosine similarity or a negative Euclidean distance may be computed as a similarity score. The loss calculator 150 may compute a triplet loss based on the similarity score of the matching query-image pair \tilde{s}(q, i) and the similarity scores of non-matching query-image pairs \tilde{s}(q, i′) and \tilde{s}(q′, i), as follows:

[symbol]

=Σ_{(q,i)∈D}[α−\tilde{s}(q,i)+\tilde{s}(q,i′)]₊+[α−\tilde{s}(q,i)+\tilde{s}(q′,i)]₊ Equation (3)

Wherein the [•]+ operation denotes max (0, •) and α denotes a margin hyperparameter. The non-matching query feature q′ and the non-matching region feature i′ may be randomly selected to generate random negative non-matching samples for the purposes of training. The triplet loss may be back-propagated to the image encoder 110 and the query encoder 120 so that the region feature weighting module 113 and the word feature weighting module 123 may update the weights for the region features and the weights for the word features, respectively, to minimize or converge the triplet loss. The triplet loss may be determined to be minimized or converged when the triplet loss has reached a predetermined minimum value, or a constant value with a preset margin. The image encoder 110 and the query encoder 120 may be jointly trained based on the triple loss.

In an inference phase, the similarity function module 130 may compute a similarity score between an input query and each of a plurality of input images, and may provide the similarity scores to the image selection module 140. The image selection module 140 may rank the input images based on the similarity scores and may select candidate images based on the ranking. For example, a preset percentage (e.g., top 10% or 20% images) or a preset number of images (e.g., 100 images having the highest similarity scores) may be selected from the plurality of input images based on the ranking. Alternatively, or combined with the usage of the ranking, a predetermined similarity threshold may be applied to select candidate images. For example, any image having a similarity score that is higher than the predetermined similarity threshold may be selected as a candidate image, or among the images selected based on the ranking, only the images having a similarity score that is higher than the predetermined similarity threshold are selected as candidate images.

The candidate images are passed into the fine search model 200, and the fine search model 200 may select at least one image from the candidate images and present the selected at least one image as a matching result of the input query.

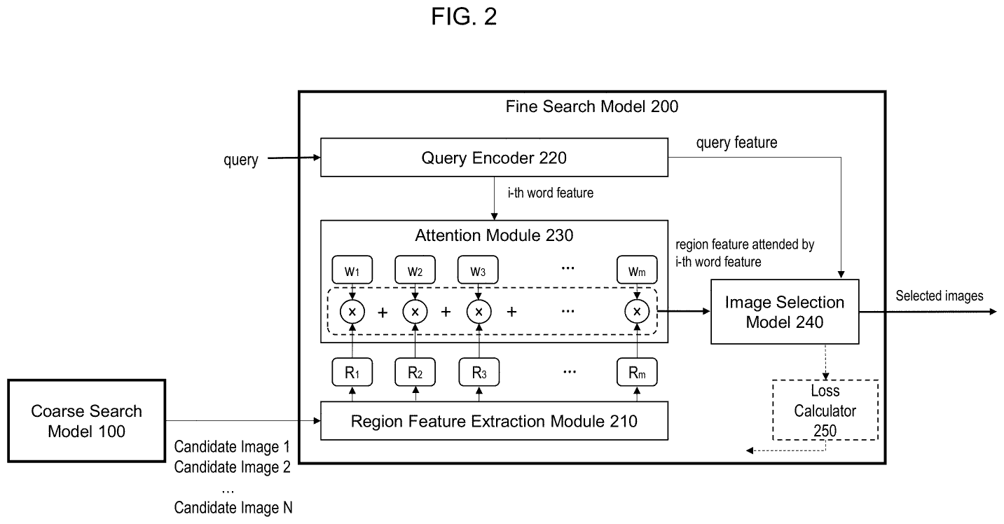

FIG. 2 illustrates a structure of the fine search model according to embodiments of the present disclosure.

As shown in FIG. 2, the fine search model 200 receives candidate images from the coarse search model 100, and also receives the query which has been input to the coarse search model 100 to obtain the candidate images.

The fine search model 200 may include a region feature extraction module 210, a query encoder 220, an attention module 230, and an image selection module 240. The fine search model 200 may compute a similarity score of each of the candidate images one by one in sequence.

When a candidate image is input to the region feature extraction module 210, the region feature extraction module 210 may identify regions of objects or scenes from a candidate image, and may extract region features from the identified regions. When m regions are identified from the candidate image, region feature extraction module 210 may extract m region features R₁, R₂, R₃, . . . Rₘ from the candidate image.

In the meantime, the query encoder 220 may identify words included in the query, and may extract a word feature (e.g., a vector representing the word feature) from each of the words. When there are n words in the query, the query encoder 220 may extract a first word feature, a second word feature, . . . , and an n-th word feature.

The attention module 230 may determine weights w₁, w₂, w₃, . . . wₘ which respectively correspond to the region features R₁, R₂, R₃, . . . Rₘ of a candidate image for an i-th word feature, wherein i∈1, 2, . . . , and n. The attention module 230 may apply the weights w₁, w₂, w₃, . . . wₘ to the region features R₁, R₂, R₃, . . . Rₘ, respectively, and add the weighted region features w₁R₁, w₂R₂, w₃r₃, . . . , wₘRₘ to obtain an aggregated region feature value. The aggregated region feature value is fed into the image selection module 240 as a region feature attended by the i-th word feature.

For example, when there are three word features extracted from three words of the query, the attention module 230 may compute (1) a first set of weights w₁₁, w₁₂, w₁₃, . . . w₁ₘ that correspond to the region features R₁, R₂, R₃, . . . Rₘ of a first candidate image, for the first word feature (2) a second set of weights w₂₁, w₂₂, w₂₃, . . . w₂ₘ that correspond to the region features R₁, R₂, R₃, . . . , Rₘ of the first candidate image, for the second word feature, and (3) a third set of weights w₃₁, w₃₂, w₃₃, . . . w₃ₘ that correspond to the region features R₁, R₂, R₃, . . . , Rₘ of the first candidate image, for the third word feature. The attention module 230 may apply the first set of weights w₁₁, w₁₂, w₁₃, . . . w₁ₘ to the region features R₁, R₂, R₃, . . . , Rₘ, respectively, and may add the weighted region features w₁₁R₁, w₁₂R₂, w₁₃R₃, . . . , m₁ₘRₘ to obtain a first aggregated region feature value for the first word feature. The attention module 230 may apply the second set of weights w₂₁, w₂₂, w₂₃, . . . w₂ₘ to the region features R₁, R₂, R₃, . . . Rₘ, respectively, and may add the weighted region features w₂₁R₁, w₂₂R₂, w₂₃R₃, . . . , w₂ₘRₘ to obtain a second aggregated region feature value for the second word feature. The attention module 230 may apply the third set of weights w₃₁, w₃₂, w₃₃, . . . w₃ₘ to the region features R₁, R₂, R₃, . . . , Rₘ, respectively, and may add the weighted region features w₃₁R₁, w₃₂R₂, w₃₃R₃, . . . , w₃ₘRₘ to obtain a third aggregated region feature value for the third word feature.

The image selection module 210 may compute a similarity score (e.g., a cosine similarity or a negative Euclidean distance) between a region feature and a query feature. In particular, the image selection module 210 may use a normalized similarity function to compute a similarity score for each word feature, and may apply mean aggregation the similarity scores to obtain a final image-query similarity score. The final image-query similarity score may be also referred to as “attended similarity score.”

For example, the image selection module 210 may compute a first similarity score between the first aggregated region feature and the first word feature, a second similarity score between the second aggregated region feature and the second word feature, and a third similarity score between the third aggregated region feature and the third word feature, and may compute a weighted sum or an average of the first similarity score, second similarity score, and the third similarity score as the final image-query similarity score.

The image selection module 210 may rank the candidate images based on the final image-query similarity scores of the candidate images, and may select at least one image based on the ranking of the candidate images. For example, a preset percentage (e.g., top 10% or 20% images) or a preset number of images (e.g., 100 images having the highest similarity scores) may be selected from the candidate images based on the ranking, and may be presented to the user in the order of the ranking. Alternatively, or combined with the usage of the ranking, a predetermined similarity threshold may be applied to select candidate images. For example, any candidate image having a similarity score that is higher than the predetermined similarity threshold may be selected, or among the candidate images selected based on the ranking, only the images having a similarity score that is higher than the predetermined similarity threshold are selected as a response to the query.

Additionally, the fine search model 200 may include a loss calculator 250 when an electronic device including the fine search model 200 updates the fine search model 200 based on on-device learning. The loss calculator 250 may be omitted if the electronic device uses the fine search model 200 as a pre-trained fixed model. In an embodiment of the present disclosure, during a training process, the loss may be computed only at the fine search stage for example using Equation (3), without computing the loss at the coarse search stage, but the embodiment is not limited thereto.

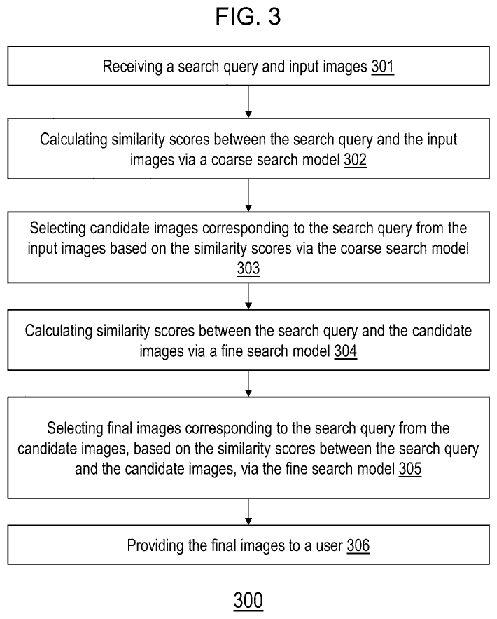

FIG. 3 is a flowchart illustrating a method 300 of performing multimodal image retrieval according to embodiments of the present disclosure.

As shown in FIG. 3, the method 300 may include operation 301 of receiving a search query and input images, operation 302 of calculating similarity scores between the search query and each of the input images via a coarse search model, operation 303 of selecting candidate images corresponding to the search query from the input images, based on the similarity scores between the search query and each of the input images, via the coarse search model, operation 304 of calculating similarity scores between the search query and each of the candidate images via a fine search model, operation 305 of selecting at least one final image corresponding to the search query from the candidate images, based on the similarity scores between search query and each of the candidate images, via the fine search model, and operation 306 of providing the at least one final image to a user. The coarse search model and the fine search model may be cascaded as shown in FIGS. 1 and 2.

In operation 301, the search query may be obtained from a user input that is received through a communication interface or an input interface. The user input may be a text input or a voice signal that is converted into text information. The input images may be all the photos retrieved from a local data storage (e.g., a photo gallery) or an external data storage. For example, when a search query stating “a woman is throwing a Frisbee in the park” is input, the method 300 may identify one or more images corresponding to the search query from all the photos stored in the photo gallery.

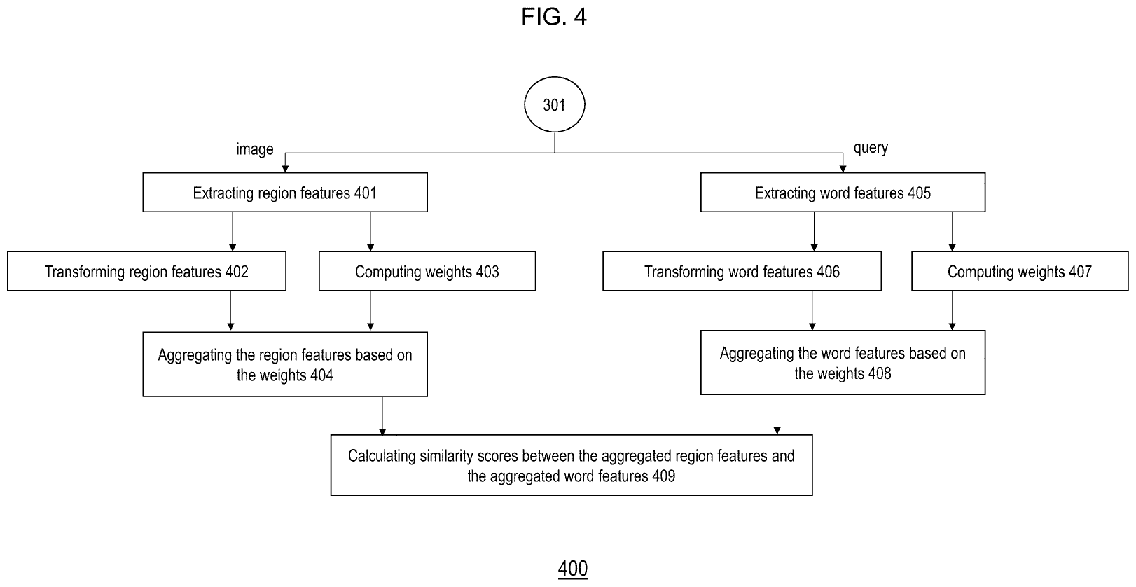

In operation 302, a region feature (e.g., each of a plurality of regions features of an input image) is computed independent of a query feature (e.g., each of a plurality of word features of the search query), and similarity scores between the region feature and the query feature are computed for each of the input images, via the coarse search model without using a cross-attention algorithm. Operation 302 may be performed by the image encoder 110 and the query encoder 120 of FIG. 1. Operation 302 will be further described with reference to FIG. 4.

In operation 303, candidates images corresponding to the search query are selected via the coarse search model based on the similarity scores calculated in operation 302. Operation 302 may be performed by the similarity function module 130 illustrated in FIG. 1.

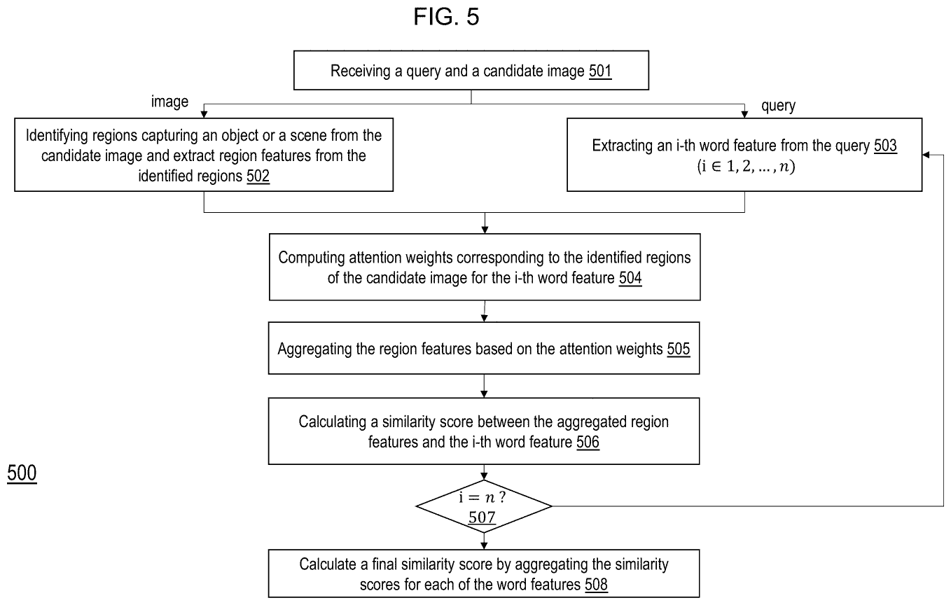

In operation 304, similarity scores between the search query and each of the candidate images may be computed via a fine search model which uses a cross-attention algorithm. Operation 304 may be performed by the fine search model 200 illustrated in FIG. 2, and will be further described with reference to FIG. 5.

In operation 305, at least one final image corresponding to the search query is selected from the candidate images, based on the similarity scores between search query and each of the candidate images, via the fine search model.

In operation 306, at least one final image is displayed on a user device. When the fine search model is executed on a server, the final image is transmitted from the server to the user device, so as to be displayed on the user device.

FIG. 4 is a flowchart illustrating a method 400 of selecting candidate images via a coarse search model according to embodiments of the present disclosure. The method 400 may correspond to operation 302 of FIG. 3.

The method 400 includes a first sequence of data processing steps directed to operations 401-404, and a second sequence of data processing steps directed to operations 405-408.

The first sequence of data processing steps includes operation 401 of extracting region features from an input image (e.g., region features that represent a plurality of regions identified from the input image), operation 402 of transforming the region features by projecting the region features into a joint embedding space, operation 403 of computing weights to be applied to the transformed region features, and operation 404 of aggregating the region features based on the weights. Operations 401-404 may be performed via the region feature extraction module 111, the region feature transformation module 112, the region feature weighting module 113, and the region feature aggregation module 114 of FIG. 1, respectively,

The second sequence of data processing steps includes operation 405 of extracting word features from the search query, operation 406 of transforming the word features by projecting the word features into the joint embedding space, operation 407 of computing weights to be applied to the transformed word features, and operation 408 of aggregating the word features based on the weights. operations 405-408 may be performed via the word feature extraction module 121, the word feature transformation module 122, the word feature weighting module 123, and the word feature aggregation module 124 of FIG. 1, respectively,

The method 400 further includes operation 409 of calculating a similarity score between a vector value of the aggregated region features and a vector value of the aggregated word features, for each of the words included in the search query, and a weighted sum or a normalized average of the similarity scores as a similarity score for the input image. Operation 409 may be performed by the similarity function module 130 of FIG. 1. The method 400 may be iterated for each of the input images to obtain a similarity score for each of the input images.

FIG. 5 is a flowchart illustrating a method 500 of selecting final images from the candidate images via a fine search model according to embodiments of the present disclosure; The method 500 may correspond to operation 304 of FIG. 3.

The method 500 may include operating 502 of receiving a query and a candidate image, operation 502 of identifying regions capturing an object or a scene from the candidate image, and extracting region features from the identified regions, operation 503 of extracting an i-th word feature from the search query, operation 504 of computing attention weights corresponding to the identified regions of the candidate image for the i-th word feature, operation 505 of aggregating the region features based on the attention weights, operation 506 of calculating a similarity score between the aggregated region features and the i-th word feature, and operation 507 of determining whether the i-th word feature is the last word feature among a plurality of words included in the search query, and operation 508 of calculating a final similarity score by aggregating the similarity scores for each of the word features when the i-th word feature is the last word. The method 500 may be performed by the fine search model 200 of FIG. 2.

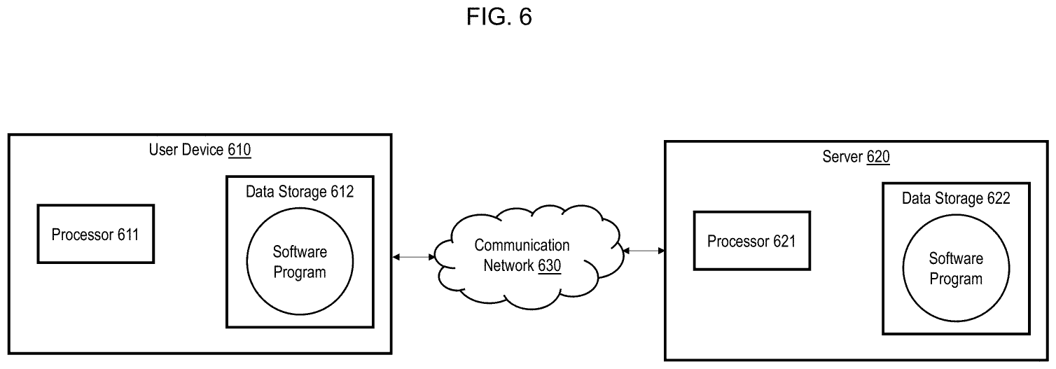

FIG. 6 is a diagram of devices for performing a multimodal retrieval task according to embodiments. FIG. 6 includes a user device 610, a server 620, and a communication network 630. The user device 610 and the server 620 may interconnect via wired connections, wireless connections, or a combination of wired and wireless connections.

The user device 610 includes one or more devices (e.g., a processor 611 and a data storage 612) configured to retrieve an image corresponding to a search query. For example, the user device 610 may include a computing device (e.g., a desktop computer, a laptop computer, a tablet computer, a handheld computer, a smart speaker, a server, etc.), a mobile phone (e.g., a smart phone, a radiotelephone, etc.), a camera device, a wearable device (e.g., a pair of smart glasses, a smart watch, etc.), a home appliance (e.g., a robot vacuum cleaner, a smart refrigerator, etc.), or a similar device. The data storage 612 of the user device 610 may include both of the coarse search model 100 and the fine search model 200. Alternatively, the user device 610 stores the coarse search model 100 and the server 620 stores the fine search model 200, or vice versa.

The server 620 includes one or more devices (e.g., a processor 621 and a data storage 622) configured to train the coarse search model 100 and the fine search model 200, and/or retrieve an image corresponding to a search query that is received from the user device 610. The data storage 622 of the server 620 may include both of the coarse search model 100 and the fine search model 200. Alternatively, the user device 610 stores the coarse search model 100 and the server 620 stores the fine search model 200, or vice versa.

The communication network 630 includes one or more wired and/or wireless networks. For example, network 1300 may include a cellular network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) may perform one or more functions described as being performed by another set of devices.

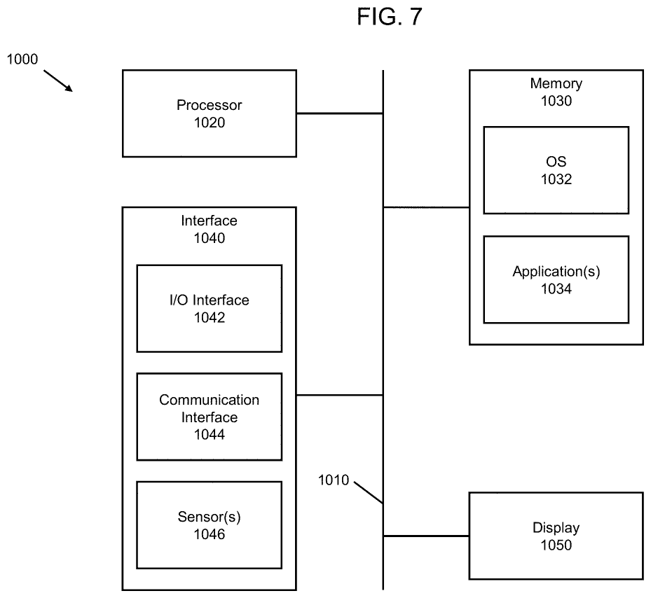

FIG. 7 is a diagram of components of one or more electronic devices of FIG. 6 according to an embodiment. An electronic device 1000 in FIG. 7 may correspond to the user device 610 and/or the server 620.

FIG. 7 is for illustration only, and other embodiments of the electronic device 1000 could be used without departing from the scope of this disclosure. For example, the electronic device 1000 may correspond to a client device or a server.

The electronic device 1000 includes a bus 1010, a processor 1020, a memory 1030, an interface 1040, and a display 1050.

The bus 1010 includes a circuit for connecting the components 1020 to 1050 with one another. The bus 1010 functions as a communication system for transferring data between the components 1020 to 1050 or between electronic devices.

The processor 1020 includes one or more of a central processing unit (CPU), a graphics processor unit (GPU), an accelerated processing unit (APU), a many integrated core (MIC), a field-programmable gate array (FPGA), or a digital signal processor (DSP). The processor 1020 is able to perform control of any one or any combination of the other components of the electronic device 1000, and/or perform an operation or data processing relating to communication. For example, the processor 1020 may perform the methods 300, 400, and 500 illustrated in FIGS. 3-5 based on a search query and a plurality of input images. The processor 1020 executes one or more programs stored in the memory 1030.

The memory 1030 may include a volatile and/or non-volatile memory. The memory 1030 stores information, such as one or more of commands, data, programs (one or more instructions), applications 1034, etc., which are related to at least one other component of the electronic device 1000 and for driving and controlling the electronic device 1000. For example, commands and/or data may formulate an operating system (OS) 1032. Information stored in the memory 1030 may be executed by the processor 1020. In particular, the memory 1030 may store the coarse search model 100, the fine search model 200, and a plurality of images.

The applications 1034 include the above-discussed embodiments. These functions can be performed by a single application or by multiple applications that each carry out one or more of these functions. For example, the applications 1034 may include an artificial intelligence (AI) model for performing the methods 300, 400, and 500 illustrated in FIGS. 3-5.

The display 1050 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 1050 can also be a depth-aware display, such as a multi-focal display. The display 1050 is able to present, for example, various contents, such as text, images, videos, icons, and symbols.

The interface 1040 includes input/output (I/O) interface 1042, communication interface 1044, and/or one or more sensors 1046. The I/O interface 1042 serves as an interface that can, for example, transfer commands and/or data between a user and/or other external devices and other component(s) of the electronic device 1000.

The communication interface 1044 may enable communication between the electronic device 1000 and other external devices, via a wired connection, a wireless connection, or a combination of wired and wireless connections. The communication interface 1044 may permit the electronic device 1000 to receive information from another device and/or provide information to another device. For example, the communication interface 1044 may include an Ethernet interface, an optical interface, a coaxial interface, an infrared interface, a radio frequency (RF) interface, a universal serial bus (USB) interface, a Wi-Fi interface, a cellular network interface, or the like. The communication interface 1044 may receive videos and/or video frames from an external device, such as a server.

The sensor(s) 1046 of the interface 1040 can meter a physical quantity or detect an activation state of the electronic device 1000 and convert metered or detected information into an electrical signal. For example, the sensor(s) 1046 can include one or more cameras or other imaging sensors for capturing images of scenes. The sensor(s) 1046 can also include any one or any combination of a microphone, a keyboard, a mouse, and one or more buttons for touch input. The sensor(s) 1046 can further include an inertial measurement unit. In addition, the sensor(s) 1046 can include a control circuit for controlling at least one of the sensors included herein. Any of these sensor(s) 1046 can be located within or coupled to the electronic device 1000. The sensor(s) 1046 may receive a text and/or a voice signal that contains one or more queries.

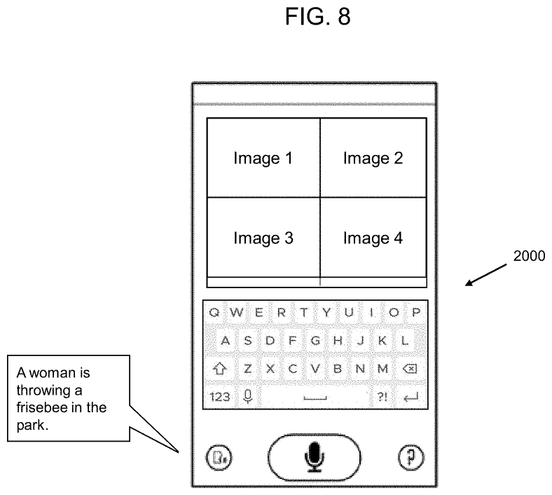

FIG. 8 illustrates a diagram of a mobile device according to embodiments of the disclosure.

Referring to FIG. 8, a mobile device 2000 may receive a search query (e.g., “A woman is throwing a Frisbee in the park”) via a microphone, a virtual keyboard, or a communication interface. The mobile device 2000 may input the search query and each of the images retrieved from a photo gallery of the mobile device 200 to a multimodal image retrieval model including the coarse search model 100 and the fine search model 200, and may output one or more images (e.g., image 1, image 2, image 3, and image 4) as a search result corresponding to the search query. The one or more images are displayed in the order of similarity between each of the images and the search query.

The multimodal retrieval process may be written as computer-executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to electronic device 100, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The multimodal retrieval process may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of server 106.

The foregoing disclosure provides illustration and description, but is not intended to be exhaustive or to limit the implementation to the precise form disclosed. Modifications and variations are possible in light of the above disclosure or may be acquired from practice of the implementation.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

A model related to the neural networks described above may be implemented via a software module. When the model is implemented via a software module (for example, a program module including instructions), the model may be stored in a computer-readable recording medium.

Also, the model may be a part of the electronic device 1000 described above by being integrated in a form of a hardware chip. For example, the model may be manufactured in a form of a dedicated hardware chip for artificial intelligence, or may be manufactured as a part of an existing general-purpose processor (for example, a CPU or application processor) or a graphic-dedicated processor (for example a GPU).

Also, the model may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server of the manufacturer or electronic market, or a storage medium of a relay server.

A coarse-to-fine cascaded approach according to the embodiments of the present disclosure provides a light-weight solution for the problem of low-latency image retrieval in a low-resource setting. The fast approximate stage relies on a simplification of an attention architecture that trades off retrieval performance for lower computational complexity while the overall cascaded approach having the coarse search model followed by fine search model, is able to achieve real-time responsiveness with a negligible loss in recall performance. Since the coarse-to-fine cascaded approach does not require Web-scale data (although Since the coarse-to-fine cascaded approach may effectively run on Web-scale data), the coarse-to-fine cascaded approach can effectively run on low-resource devices such as mobile phones, network-attached storage (NAS) devices, and in-home multimedia systems including a low-cost embedded graphic processing unit (GPU) board, and has low retrieval latency while maintaining reasonably-high ranking accuracy.

While the embodiments of the disclosure have been described with reference to the figures, it will be understood by those of ordinary skill in the art that various changes in form and details may be made therein without departing from the spirit and scope as defined by the following claims.

What is claimed is:

1. A method for multimodal content retrieval, the method comprising:
receiving a search query corresponding to a request for content;
aggregating word features extracted from the search query based on a first set of learned weights;
aggregating region features extracted from each of a plurality of images, based on a second set of learned weights, independently of the word features;
computing a similarity score between the aggregated words features and the aggregated region features for each of the plurality of images;
selecting candidate images from the plurality of images based on the similarity scores between each of the plurality of images and the search query; and
selecting at least one final image from the candidate images as a response to the search query, based on attended similarity scores of the candidate images with respect to the search query.

2. The method of claim 1, wherein the similarity score is calculated based on performing a negative Euclidean distance operation or a cosine similarity operation on the aggregated word features and the aggregated region features.

3. The method of claim 1, wherein the aggregating of the word features comprises: obtaining the first set of learned weights to be assigned to the word features based on content values of the word features independently of the region features, and
wherein the aggregating of the region features comprises: obtaining the second set of learned weights to be assigned to the region features based on content values of the region features independently of the word features.

4. The method of claim 3, wherein the content values of the word features are vector values corresponding to contextual representation of words in the search query.

5. The method of claim 3, wherein the content values of the region features are calculated by:
detecting salient regions or grid cells in each of the plurality of images;
mapping the detected salient regions or grid cells to a set of vectors; and
averaging the set of vectors.

6. The method of claim 1, wherein the aggregating of the word features comprises: transforming the word features by projecting the word features into a feature subspace, and aggregating the transformed word features based on the first set of learned weights.

7. The method of claim 1, wherein the aggregating of the region features comprises: transforming the region features by projecting the region features into a feature subspace, and aggregating the transformed region features based on the second set of learned weights.

8. The method of claim 1, wherein the word features are aggregated via a first multilayer perceptron (MLP) network, and the region features are aggregated via a second MLP network.

9. The method of claim 1, wherein the selecting of the candidate images comprises: comparing the similarity scores between each of the plurality of images and the search query with a preset threshold, and selecting the candidate images each of which has the similarity score that is greater than the preset threshold.

10. An electronic device for multimodal content retrieval, the electronic device comprising:
at least one memory storing instructions; and
at least one processor configured to execute the instructions to:
receive a search query corresponding to a request for content;
aggregate word features extracted from the search query based on a first set of learned weights;
aggregate region features extracted from each of a plurality of images, based on a second set of learned weights, independently of the word features;
compute a similarity score between the aggregated words features and the aggregated region features for each of the plurality of images;
select candidate images from the plurality of images based on the similarity score for each of the plurality of images; and
select at least one final image from the candidate images as a response to the search query, based on attended similarity scores of the candidate images with respect to the search query.

11. The electronic device of claim 10, wherein the at least one processor is further configured to execute the instructions to:
calculate the similarity score based on performing a negative Euclidean distance operation or a cosine similarity operation on the aggregated word features and the aggregated region features.

12. The electronic device of claim 10, wherein the at least one processor is further configured to execute the instructions to:
obtain the first set of learned weights to be assigned to the word features based on content values of the word features independently of the region features, and
obtain the second set of learned weights to be assigned to the region features based on content values of the region features independently of the word features.

13. The electronic device of claim 12, wherein the content values of the word features are vector values corresponding to contextual representation of words in the search query.

14. The electronic device of claim 12, wherein the at least one processor is further configured to execute the instructions to:
calculate the content values of the region features by:
detecting salient regions or grid cells in each of the plurality of images;
mapping the detected salient regions or grid cells to a set of vectors; and
averaging the set of vectors.

15. The electronic device of claim 10, wherein the at least one processor is further configured to execute the instructions to:
transform the word features by projecting the word features into a feature subspace, and aggregate the transformed word features based on the first set of learned weights.

16. The electronic device of claim 10, wherein the at least one processor is further configured to execute the instructions to:
transform the region features by projecting the region features into a feature subspace, and aggregate the transformed region features based on the second set of learned weights.

17. The electronic device of claim 10, wherein the at least one processor is further configured to execute the instructions to:
aggregate the word features via a first multilayer perceptron (MLP) network, and aggregate the region features via a second MLP network.

18. The electronic device of claim 10, wherein the at least one processor is further configured to execute the instructions to:
compare the similarity scores between each of the plurality of images and the search query with a preset threshold, and select the candidate images each of which has the similarity score that is greater than the preset threshold.
